(19) United States
(12) Patent Application Publication
(10) Pub. No.: US 2007/0174867 A1
(43) Pub. Date: Jul. 26, 2007

(54) Computer controlled system for enabling the owner/host of a television set to limit the access of designated viewers to television programs

(76) Inventors: Katherine Ann Dunning, Austin, TX (US); Cristi Nesbitt Ullmann, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/340,451

(22) Filed: Jan. 26, 2006

(51) Int. Cl. H04N 7/16

(52) U.S. Cl. 725/30; 725/29

(57) ABSTRACT

A computer controlled display system for enabling the host of a television set to limit the access of designated viewers to television programs through the television set. There is apparatus enabling a viewer to request the presentation of a selected television program on the television display, apparatus for assigning an identifier to a viewer of the television display and apparatus enabling the host of the television set to limit an identified viewer requesting access to television programs of host-selected content for a host selected time period. The apparatus enabling the host to limit access for a limited time period may be set up to automatically turn the television set off after said limited time period.

### TECHNICAL FIELD

The present invention relates to computer controlled television sets and particularly to controlling the access of designated viewers, e.g. children to television program content.

### BACKGROUND OF RELATED ART

The present state of television broadcasting and programming has been marked by a technological revolution driven by the convergence of the data processing industry with the consumer electronics industry. This has resulted in the television set viewer having “fingertip” instant access to hundreds of television programs. This of course includes program content wholly unsuitable to children and younger viewers. As a result, there has been a need to provide the owners/hosts of television sets, i.e. parents, with the means to control access to television programs. Fortunately, the technological advances have provided the resources for implementations for controlling such access.

In order to better appreciate this invention, the background of the television industry, including cable and satellite services, needs to be considered. As the demand for television programming rapidly increased, frequency channels that the Government made available for the presentation of programming by respective television stations also rapidly increased. This led to television service providers that obtained and consolidated the programs transmitted by the respective television stations to be presented to viewers at Government designated frequency channels. The original television stations would transmit at their assigned frequencies either by direct line of sight, cable or through satellites. The television service providers then received the respective program channel signals and consolidated all the data in such transmissions into an integrated data stream representative of an extensive set of television programs being presented on corresponding channels into an unitary data stream that was then compressed and transmitted to the television service provider's subscribers either via satellite or cable. The viewer could then receive this integrated data stream and extract any “live” or real-time television program through his conventional television frequency channel tuner. The provider system would extract the appropriate television program data directly from the real-time satellite of cable service provider integrated data stream. The extracted program data representing the television program would be displayed on a real-time basis on the television set display. Where the user wished to record a particular television program for future viewing, it would be extracted at its scheduled viewing period from the integrated data stream in the same manner as described, decrypted, decompressed and recorded on disk drives (DVD). Individual programs on their respective channels could still be recorded on a real-time basis by extraction. This, of course, resulted in the current state of the (Digital Video Recorder) DVR or (Personal Video Recorder) PVR industry where the user, with an appropriate PVR, could record dozens of broadcasts and transmitted television programs for future viewing on their television sets.

### SUMMARY OF THE PRESENT INVENTION

The present invention enables the owners of television sets to take advantage of the advances in the cable and satellite service provider control technologies, and PVRs to limit viewer access to the otherwise instant access to hundreds of programs resulting from these technologies.

While the present invention may be most conveniently implemented on PVRs, it will be clear from the following description that any computer controlled television system could be used to run the routines of the invention. In general, the invention relates to a computer controlled display system for enabling the host of a television set to limit the access of designated viewers to television programs through said television set that comprises a combination including a television set display, apparatus enabling a viewer to request the presentation of a selected television program on said television display, apparatus for assigning an identifier to a viewer of said television display and apparatus enabling the host of the television set to limit an identified viewer requesting access to television programs of host-selected content for a host selected time period. The host may be enabled to limit access to sets or categories of television programs of predetermined content, particularly to limit access to each set of a plurality of sets of television programs of predetermined content for a respective limited time period per set. This is particularly effective when the viewer is a child. In such a case, the host may have access to an “out of the box” implementation wherein a provider, such as a television service provider, predetermines the times and contents of the sets of television programs based upon the age of the viewers. In such an arrangement, all the host or parent has to do is enter the age of the child, and the appropriate television content and times will be presented to the identified child. The apparatus enabling the host to limit access for a limited time period may be set up to automatically turn the television set off after said limited time period.

The system further includes means for prompting a viewer requesting access to television set programs to enter his viewer identifier. This may be a spoken identifier. Finally, with a great many systems in which television programs are transmitted from a television service provider, the television service provider may set up to control all of the limitations of program content and time periods selected by the television set host.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of the system of the present invention organized around a DVR serving as the computer controlled system;

FIG. 2 is a diagrammatic view of the display screen of a television set illustrating the dialog through which the television set host may be prompted to enter data to be used to limit access to program content and to time periods for selected identified users;

FIG. 3 is a diagrammatic view of the display screen of a television set illustrating the dialog through which a potential viewer may enter his identifier, and be shown a list of the remaining programs and times to which the user will have access to the television set;

FIG. 4 is a flowchart describing how the implementation system of the present invention provides for the host of a television set limiting the access of designated viewers to television programs through said television set; and

FIG. 5 is a flowchart of an illustrative run of a process set up in FIG. 4.

### DETAILED DESCRIPTION OF THE PREFERRED EMBODIMENT

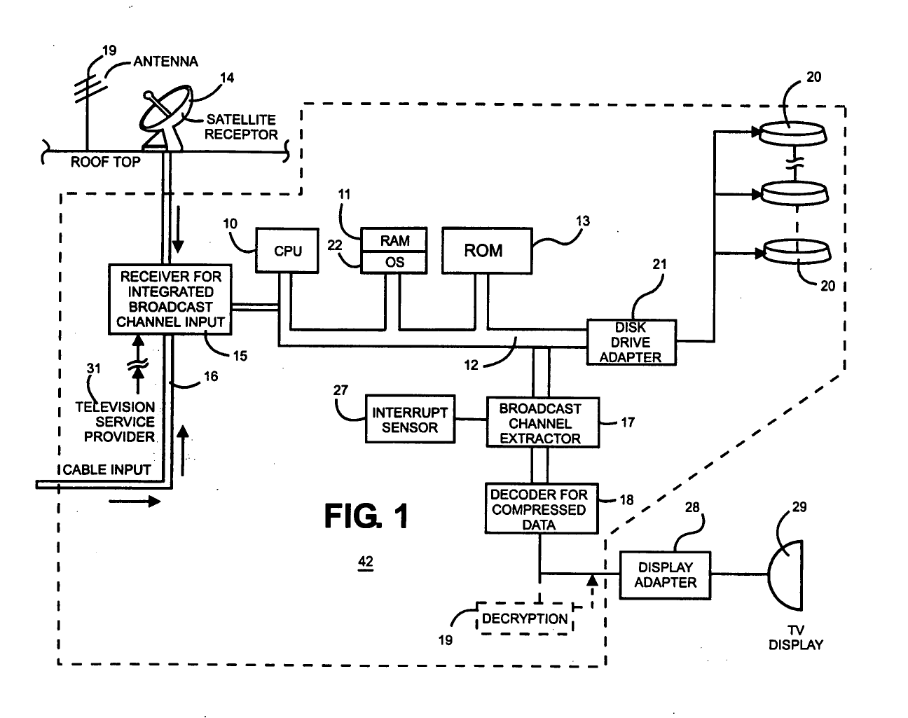

Referring to FIG. 1, there is shown a generalized view of a system of the present invention as illustratively embodied in a DVR apparatus. While the invention will be described as implemented on a DVR for convenience in illustration, it will be clear the invention may be implemented on any apparatus providing computer control of a television set so that the host control programs of this invention may be operated with the equipment. The receiver 15 at the viewer's home receives and integrates input from the satellite provider via satellite receptor 14 or cable input from the cable provider. Further, input may be provided from television service provider 31 that may combine and integrate TV programming from a wide variety of sources. The viewer's system may also still get line of sight antenna input from the local television broadcasts via roof top antenna 19.

The apparatus shown connected to receiver 15 may be conveniently housed in a television set top box or in some late systems, the whole DVR apparatus may be integrated within a unitary television set. Satellite receptor antenna 14 receives the integrated data stream that is applied to a standard receiver for integrated broadcast channel input 15. Similarly, the integrated data stream from cable may be applied through input 16 to receiver 15.

The operations involved in the present invention are controlled by a data processing system under the control of a central processing unit 10, which, in turn, is interconnected to various other components by system bus 12. An operating system (OS) 22 that runs on processor 10 provides control and is used to coordinate the functions of the various components of the control system. The OS 22 is stored in Random Access Memory (RAM) 11. The control programs 30 for the functions, including those for limiting access to television programming on television sets of the present invention may be permanently stored in Read Only Memory (ROM) 13 and moved into and out of RAM to perform their respective functions. In the normal operation for real-time television program playing, the integrated incoming data stream, under CPU control, is applied to broadcast channel extractor 17 that extracts the data representative of the television program scheduled for the channel that the user has selected on a tuner (not shown) and applies the extracted data to a conventional television display adapter 28 to be displayed on the user's television set 29.

When the incoming unitary data stream is to be recorded on the DVR, the signal is processed through a disk drive adapter 21 and stored on disk drives 20. In the conventional operation of a DVR, the television program scheduled for a given channel at a given time is extracted by extractor 17, and then stored on a disk drive 20 provided on the DVR. This individual program would be recorded and, thus, stored on the disk drive either in response to either advance scheduling by the user for such a recording or a user request to record a real-time presented television program.

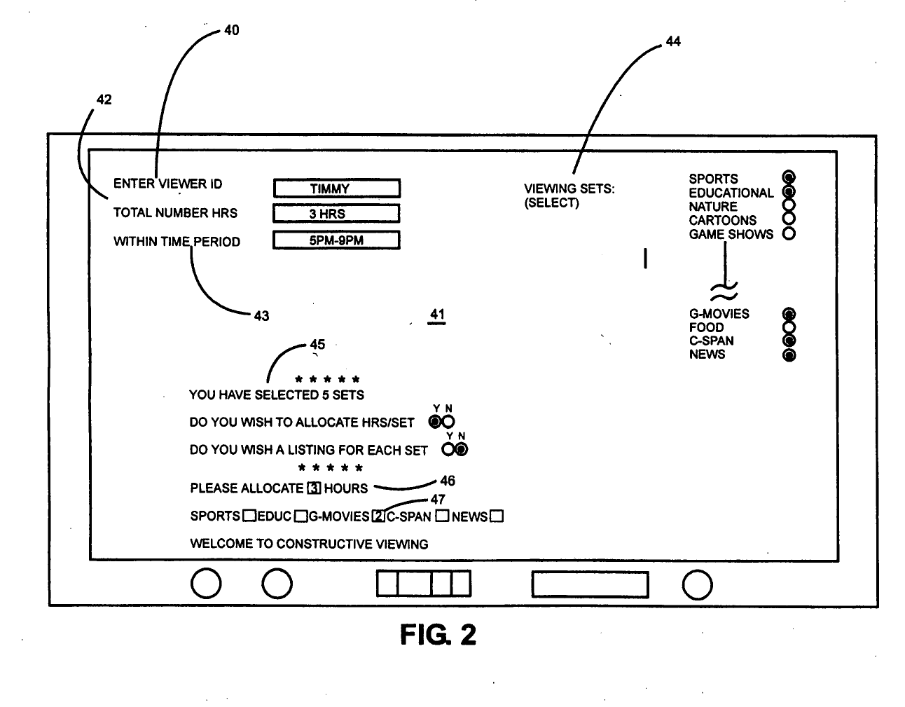

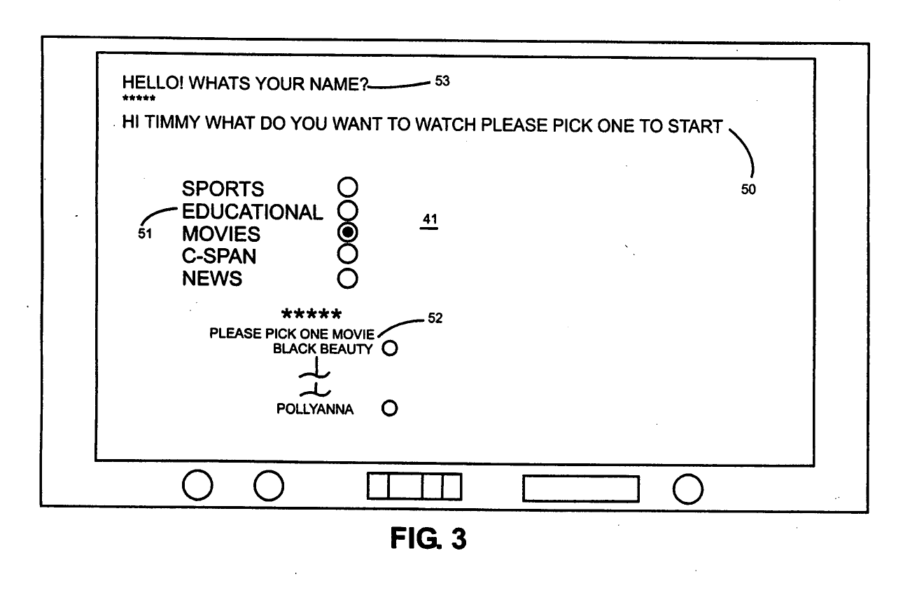

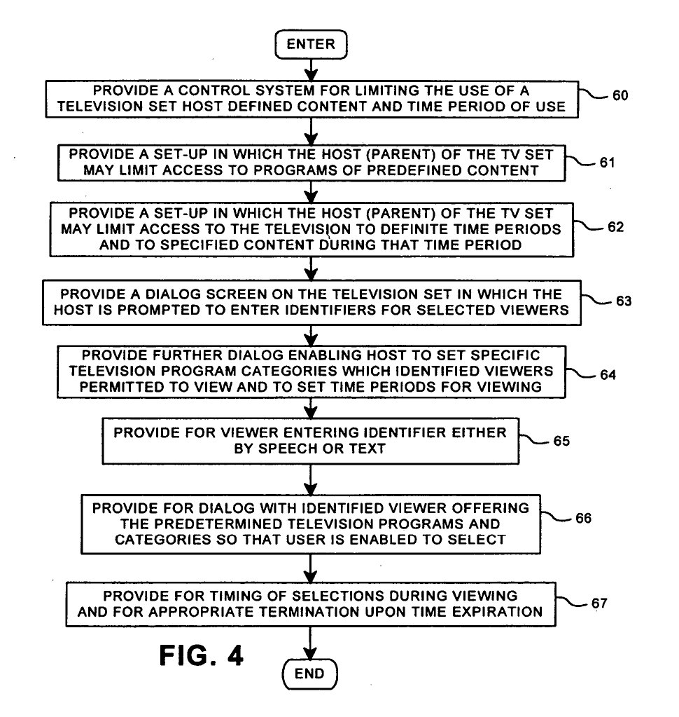

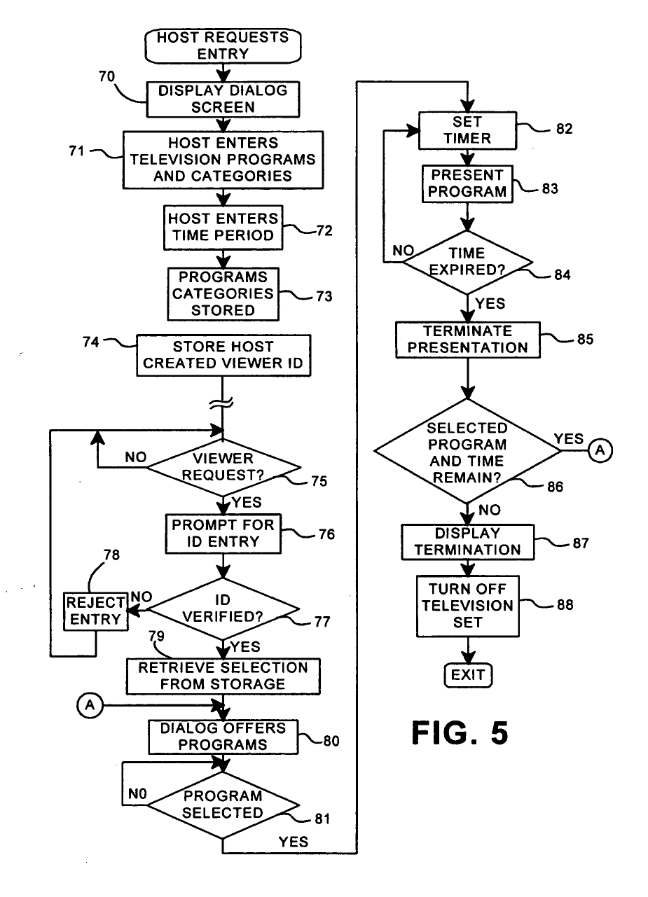

During playback, the viewer, via the control of OS 22, selects a television program recorded on disk drive 20 that is then applied to display adapter via connector 30 and presented on the TV display 29. It will be understood that the present invention implementation wherein the TV owner may limit identified user access to predetermined programming over predetermined time periods will be applicable to both such recorded television programs, as well as television programs presented live. The interrupt program of this invention is stored in RAM 11 and is responsive to input from an interrupt timer 27 that tracks the presented programming to insure that the time limitations are enforced. The interrupt feature may be set up to automatically turn the television set off when all of the timed television is completed. This will be described in greater detail with respect to the illustrative television displays of FIGS. 2 and 3, and the flowcharts of FIGS. 4 and 5.

With reference to FIG. 2, there is illustrated a diagrammatic view of the display screen 41 of a television set illustrating the dialog through which the television set host may be prompted to enter data to be used to limit access to program content and to time periods for selected identified users. The host or owner of the television set is prompted to enter the ID 40 to be used by the restricted user or viewer, e.g. “Timmy”, the owner's child. The owner is also prompted to enter the total viewing hours permitted per day 42, and the time period 43 within which viewing is permitted. The owner is also presented with several viewing sets or categories of television programs 44 from which the owner has selected five categories. The owner's selections are then summarized 45. The owner is then prompted to allocate hours per selected category or set, and asked if he wished a breakdown of the listing of the programs in each set should he wish to make more specific choices. Since the owner has indicated that he wishes to allocate hours to the categories, he is prompted to allocate his selected hours 46. Accordingly, such allocation is made 47.

Now that the television set owner has set up the limitations, there is shown in FIG. 3 the television screen 41 presented to the viewer, Timmy, when he turns on the TV. Viewer is prompted for his name 53, which he may enter by the text on a control pad or the set may permit the viewer to speak his name or ID. Once the viewer is identified, he is prompted 50 to pick a starting program from a presented list 51. Since the viewer has selected a category, Movies, he is prompted further to select a movie from the category. The selection and viewing continue with appropriate timing that the viewer may interrupt and resume until appropriate owner selected times are completed. At such times, the viewer may be prompted to select another item or category on which times remain. If the total viewing time has expired, the television set may be automatically turned off.

Now, with reference to the programming shown in FIG. 4, there will be described how the system and programs of the present invention are set up. There is provided a basic control system for limiting the time of use of a television set, as well as the television program as defined by the television set owner or host, step 60. Accordingly, a set up or routine is provided whereby the host may limit access to only programs of preselected content, step 61. A set up is provided whereby the host may limit access to defined time periods and to defined content during such time periods, step 62. In the implementation, a dialog television screen is provided to prompt the host to set up identifiers for his permitted users, step 63. Also, there is provided an additional dialog screen enabling the host to set specific television program categories that identified viewers are permitted to view, as well as the time periods for such viewing, 64. Then, provision is made for permitting the viewer to enter his ID through text or speech, step 65. Provision is made for appropriate dialog with the permitted viewer so that the viewer may be offered the permitted categories and programs, step 66. Finally, provision is made for the timing of the viewer selections and for appropriate termination upon expiration of time, step 67.

Now, with reference to the flowchart of FIG. 5, a simplified illustrative run of the process set up in FIG. 4 will be described. When the host requests an entry screen, he is presented, step 70, with a restriction entry dialog screen, e.g. FIG. 2. The host then enters his selected programs and categories, step 71. The host enters permitted time periods, step 72. The entered times, programs and categories are stored, step 73. The host then creates IDs for the permitted viewers that are also stored, step 74.

The television set control system then awaits a viewer request, step 75. If Yes, the viewer is prompted for his ID, step 76. There is a verification, step 75. If No, the ID entry is rejected, and the process returns to step 75. If Yes, there is ID verification, the host selections to be offered are retrieved from storage, step 79, and the dialog offers selected television programs and categories to the viewer, step 80. A determination is made in step 81 as to whether the viewer has selected a host approved program. If Yes, the television program is presented on screen, step 82. A timer is usually set for the host selected time periods, step 83, and then a determination is made continuously as to whether the monitored time has expired, step 84. If Yes, the television program being presented is terminated, step 85, and a further determination is made as whether there is any remaining other program and appropriate time, step 86. If Yes, the process is branched via “A” back to the dialog offering, step 80. If No, a viewing termination message may be displayed, step 87, the television set is turned off, step 88, and the session is exited.

While the above preferred embodiment illustrates owner selection and control implemented at the level of the individual television program and preferably on a DVR, the invention may be implemented at the level of the television service provider in the case where there is such a service provider providing the television program services to the television set owner. All of the dialogs offered to host on the screen may come directly from such service provider. All of the television times and selected programming may be under the control of the service provider.

Although certain preferred embodiments have been shown and described, it will be understood that many changes and modifications may be made therein without departing from the scope and intent of the appended claims.

What is claimed is:

1. A computer controlled system for enabling the host of a television set to limit the access of designated viewers to television programs through said television set comprising:
a television set display;
apparatus enabling a viewer to request the presentation of a selected television program on said television display;
apparatus for assigning an identifier to a viewer of said television display; and
apparatus enabling the host of the television set to limit an identified viewer requesting access to television programs of host-selected content for a host selected time period.

2. The system of claim 1 wherein said apparatus enabling the host to limit enables the host to limit access to sets of television programs of predetermined content.

3. The system of claim 2 wherein said enabling apparatus enables the host to limit access to each set of a plurality of sets of television programs of predetermined content for a respective limited time period per set.

4. The system of claim 1 further including means for prompting a viewer requesting access to television set programs to enter his viewer identifier.

5. The system of claim 4 further including speech recognition means enabling said requesting viewer to speak his viewer identifier.

6. The system of claim 3 wherein said apparatus enabling the host to limit access for a limited time period automatically turns the television set off after said limited time period.

7. The system of claim 3 wherein said system is implemented in a digital video recorder.

8. A computer controlled method for enabling the host of a television set to limit the access of designated viewers to television programs through said television set display comprising:
enabling a viewer to request the presentation of a selected television program on said television display;
assigning an identifier to a viewer of said television display; and
enabling the host of the television set to limit an identified viewer requesting access to television programs of host-selected content for a host selected time period.

9. The method of claim 8 wherein said host is enabled to limit access to sets of television programs of predetermined content.

10. The method of claim 9 wherein said host is enabled to limit access to each set of a plurality of sets of television programs of predetermined content for a respective limited time period for each set.

11. The method of claim 10 wherein:
said viewer is a child;
said each set of said plurality of sets has its predetermined television programs and time based upon the age of the child;
and further including the step of:
entering the child's age by the host whereby the predetermined programs and time of presentation for the child are selected.

12. The method of claim 8 further including the step of prompting a viewer requesting access to television set programs to enter his viewer identifier.

13. The method of claim 10 wherein the television set is automatically turned off when the limited time period set by said host is attained.

14. The method of claim 10 wherein:
said television programs are transmitted from a television service provider; and
said television service provider controls the limitations of program content and time periods selected by the television set host.

15. A computer program having code recorded on a computer readable medium for a computer controlled system for enabling the host of a television set to limit the access of designated viewers to television programs through said television set comprising:
a television set display;
apparatus enabling a viewer to request the presentation of a selected television program on said television display;
apparatus for assigning an identifier to a viewer of said television display; and
apparatus enabling the host of the television set to limit an identified viewer requesting access to television programs of host-selected content for a host selected time period.

16. The computer program of claim 15 wherein said apparatus enabling the host to limit enables the host to limit access to sets of television programs of predetermined content.

17. The computer program of claim 16 wherein said enabling apparatus enables the host to limit access to each set of a plurality of sets of television programs of predetermined content for a respective limited time period per set.

18. The computer program of claim 15 further including:
means for prompting a viewer requesting access to television set programs to enter his viewer identifier; and
speech recognition means enabling said requesting viewer to speak his viewer identifier.

19. The computer program of claim 17 wherein said apparatus enabling the host to limit access for a limited time period automatically turns the television set off after said limited time period.

20. The computer program of claim 16 wherein:
said television programs are transmitted from a television service provider; and
said television service provider controls the limitations of program content and time periods selected by the television set host.
